(19) United States
(12) Patent Application Publication
(10) Pub. No.: US 2005/0051006 A1
(43) Pub. Date: Mar. 10, 2005

(54) Food slicer with an insertion housing

(75) Inventors: Joze Barbaric, Maribor (SI); Peter Kovacic, Gomilsko (SI)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/928,222

(22) Filed: Aug. 27, 2004

Related U.S. Application Data
(63) Continuation of application No. PCT/EP03/01754, filed on Feb. 20, 2003.

(30) Foreign Application Priority Data
Feb. 27, 2002 (DE) 102 08 489.0

(51) Int. Cl. B26D 7/06

(52) U.S. Cl. 83/167; 83/707; 83/478; 83/571

(57) ABSTRACT

A food slicer has a substantially parallelepiped or approximately cuboid housing with a rear wall and a front wall disposed at a distance from the rear wall. An interspace is formed between the two walls, the space is accessible via a removable housing wall, and it is used to receive a drive unit with a drive motor and a gear mechanism that drive a circular cutting blade at the front wall. In order to provide the housing of such a food slicer with a high degree of rigidity in a simple manner and to create a food slicer which is easy to assemble, the removable housing wall is formed by one of the narrow-sided housing walls and the other housing walls are joined to form a unit, thereby resulting in a very stable food slicer structure.

### CROSS-REFERENCE TO RELATED APPLICATION

This is a continuing application, under 35 U.S.C. § 120, of copending international application No. PCT/EP03/01754, filed Feb. 20, 2003, which designated the United States; this application also claims the priority, under 35 U.S.C. § 119, of German patent application No. 102 08 489.0, filed Feb. 27, 2002; the prior applications are herewith incorporated by reference in their entirety.

### BACKGROUND OF THE INVENTION

### Field of the Invention

The invention relates to slicers and in particular to a food slicer. The slicer has an at least approximately parallelepipedal housing which has a rear wall and a front wall arranged at a distance from the rear wall. An interspace is formed as a result which is accessible via a removable housing wall and serves for receiving a drive unit. The drive unit has a drive motor and a gear unit and is provided for driving a round blade which is assigned to the front wall,

A food slicer of the generic type is known from German published patent application DE 26 01 269. The prior art household slicer comprises a one-piece housing consisting of a lower part and an upper part. The upper part is designed in the form of a frame and is closed by a cover plate. A disk-shaped recess is fashioned in the cover plate. A disk-shaped round blade is accommodated in the recess, mounted in the upper part and driven rotationally by an electric motor disposed behind the upper part.

It is a disadvantage of the prior art household slicer that the construction of the housing is very complicated and its assembly is very involved.

### SUMMARY OF THE INVENTION

It is accordingly an object of the invention to provide a food slicer, which overcomes the above-mentioned disadvantages of the heretofore-known devices and methods of this general type and which provides for a housing of the slicer that is simple and very rigidity. It is also an object of the invention to produce a food slicer, the assembly of which is rendered easier.

With the foregoing and other objects in view there is provided, in accordance with the invention, a slicer, comprising:

a substantially parallelepipedal housing formed with a front wall, a rear wall spaced apart from said front wall and forming an interspace therewith;

said housing further having a plurality of relatively narrow side walls between said front wall and said rear wall, said side walls including a removable housing wall enabling access to said interspace between said front wall and said rear wall, and remaining side walls forming a unitary structure;

a drive unit configured for insertion into said interspace, said drive unit having a drive motor and a gear unit connected to said drive motor for driving a round cutting blade disposed at said front wall of said housing.

Due to the fact that one of the narrow-side housing walls is removable and the other housing walls are connected to form a unit, a simple housing construction with great rigidity is obtained. By virtue of the other housing walls being connected to form a unit, a very rigid construction of the housing is obtained. This connected unit forms a basic housing, into which the necessary components such as, for example, drive motor and gear unit can be inserted via a narrow side of the at least approximately parallelepipedal housing. The approximately parallelepipedal housing, which forms a connected unit, has an opening on one of its narrow sides which can be closed by a removable housing wall. The housing consequently forms a stable unit, the interior of which is accessible via a narrow-side opening. This has the advantage that the housing connected to form a unit already has very great rigidity and the removable housing wall can be fastened to it in a simple way.

In accordance with a preferred embodiment, the removable housing wall is formed by the end wall of the housing. As the end wall is removable, different models of food slicer can have a basic housing of the same kind, into which model-specific end walls can be inserted. The same basic housing can thus be used for different models. Model differences, which come about owing to, for example, design or operating elements, can be realized in the form of different end walls which can be inserted into a basic housing of the same kind. A large number of model variants can thus be produced without the variety of parts increasing greatly.

In accordance with an added feature of the invention, the other housing walls which serve to form the housing along with the removable narrow-side housing wall are interconnected in one piece. The front housing wall, the rear wall and three narrow-side housing walls then form a one-piece constructional unit. In the case of metal slicers, this one-piece constructional unit can be manufactured by aluminum die-casting. In the case of plastic food slicers, the one-piece constructional unit can be manufactured by injection-molding. By virtue of the basic housing being cast or molded in one piece, additional fastening means and assembly steps for connecting the housing walls can be dispensed with. The basic housing designed in this way can consequently be produced cost-effectively. Manufacture by die-casting or injection-molding also makes it possible to form on ribs in the interior of the housing, which provide the housing with additional rigidity. By forming stiffening ribs on, great stability of the basic housing is achieved even with reduced wall thicknesses. If the housing can be produced with reduced wall thicknesses, this advantageously results in material saving.

In accordance with an additional feature of the invention, a carrier, which receives the gear unit and the drive motor, can be inserted into the housing. The assembly of the food slicer can be simplified in an especially advantageous way if a carrier is provided on which at least the drive motor and the gear unit are premounted. The carrier can be designed in the form of, for example, a frame or a baseplate. The gear unit and the drive motor can be premounted on this chassis-like construction of the carrier. Further components of the food slicer can suitably be premounted on the carrier as well. The preassembled carrier can then, in a simple assembly step, be inserted via the narrow-side opening of the basic housing and be fixed in the housing. To this end, the carrier can be supported on at least one inner side of the housing. Preferably, a guide is provided on the inner side of the housing and the carrier can be inserted into the housing by means of this guide. The guide thus makes insertion of the carrier easier and at the same time supports the carrier inside the housing in its fitting position. The insertion and support of the carrier in the interior of the housing takes place in a similar manner to the insertion and support of a drawer in a cupboard. The fitting position of the carrier is defined clearly by the guide for the carrier on the inner side of the housing. The clear definition of the fitting position for the carrier makes it possible to avoid assembly errors.

It is especially advantageous if the housing has catch means and the carrier is fixed in the catch means. When the carrier is pushed into the housing, the catch means provided engage and the carrier is thus fastened in the housing. This consequently renders it unnecessary to fasten the carrier to the housing with separate fastening means. All the components of the food slicer are therefore put into the housing by inserting the carrier, and the carrier is fastened to the housing by the engagement of the catch means. This construction results in especially simple assembly.

The catch means are preferably designed as recesses on the inner side of the housing, wherein retaining noses, which are fastened to the carrier by means of resilient catch hooks, engage. In order for it to be possible for the housing to be manufactured in a simple way, for example in one piece by injection-molding or by die-casting, it is favorable to design the recesses on the inner side of the housing. This has the advantage that the one-piece housing is easy to remove from the mold after production. As the carrier is preferably constructed in the form of a frame, it is possible in a simple way to fasten the resilient catch hooks, which have the retaining noses, to the carrier. The resilient catch hooks with the retaining noses can advantageously be formed directly on the carrier.

It is favorable if the catch means are arranged in proximity to the bearing assembly for the round blade or in proximity to the bearing assembly for a driving pinion. The catch means, which are preferably formed by resilient catch hooks, can therefore be arranged on the removable housing wall or on the bearing assembly for the round blade or on the bearing assembly for the driving pinion. According to the requirement for the rigidity of the construction, these different arrangements of catch means can be combined with one another. It is especially appropriate to provide catch means in the region of the bearing assembly for the round blade and in the region of the bearing assembly for the driving pinion. As the greatest stresses arise in the region of these two bearings, it is especially favorable to provide the catch means there.

In order to increase the rigidity of the entire drive train from the motor via the gear unit to the round blade, the carrier can in particular be connected to a bearing plate which bears the gear unit and the drive motor. Such a bearing plate provides an especially rigid connection between the first-bearing assembly for the round blade and the second bearing assembly for the driving pinion. The further advantage of such a bearing plate is that the carrier itself can be made from a material of lower strength. This has the advantage that the carrier can be manufactured cost-effectively from an inexpensive material. As the bearing plate transmits the major forces from the first bearing assembly for the round blade to the second bearing assembly for the driving pinion, it is sufficient to make this bearing plate from a superior, high-strength material.

The carrier can appropriately be connected to the end plate. In particular, it is cost-effective to design the carrier together with the end plate as a one-piece component. Stiffening ribs which are arranged to run between the carrier and the end plate can be provided. In particular, the one-piece component consisting of carrier and end plate can be made as an injection-molded plastic part or as a die-cast aluminum part.

In another preferred embodiment of the invention, the push-button for switching the drive motor on and off and any locking mechanism provided for the push-button are, in particular, integrated in the end plate. This has the advantage that the operating elements too are integrated into the end plate. This results in the particular advantage that different models of a food slicer can differ only in the construction and appearance of the end plate. Different models can be produced simply by means of different end plates. The different end plates can then have a different design. The different models can also differ in having differently designed push-buttons or a different number of push-buttons. Different models can also be brought about by the carrier having different gear units and/or drive motors. The end plates for different models can thus be designed differently, and the necessary components such as, for example, the gear unit and the drive motor can also be different according to model. The different models can then be preformed on the respective carriers. The preassembled carrier with the respective end plate can then be inserted into a generally used basic housing and fastened therein.

Other features which are considered as characteristic for the invention are set forth in the appended claims.

Although the invention is illustrated and described herein as embodied in a food slicer with an insertion housing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a perspective view of the slicer according to the invention;

FIG. 2 is a perspective view of the housing of the slicer according to the invention; and

FIG. 3 is a perspective view of a carrier with an end plate and a bearing plate carrying a gear unit and a drive motor.

### DESCRIPTION OF THE PREFERRED EMBODIMENTS

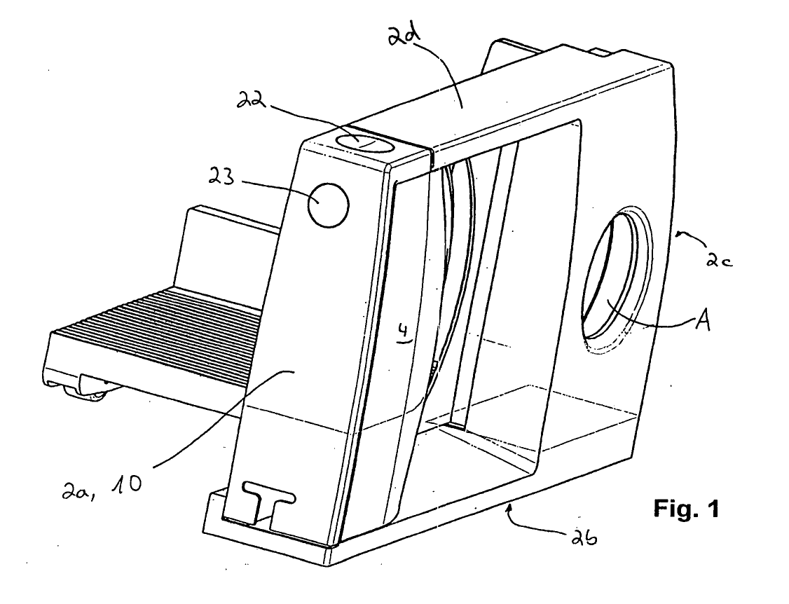

Referring now to the figures of the drawing in detail and first, particularly, to FIG. 1 thereof, there is shown an electric food slicer with a parallelepipedal housing 2. The housing 2 is substantially formed as a one-piece injection-molded plastic part and comprises a rear wall 4, a bottom surface 2b, a top surface 2d and a rear, narrow-side wall 2c. The housing 2 also has a front wall 3 opposite the rear wall 4. The front wall 3 is hidden in the view in FIG. 1 and therefore cannot be seen. The parallelepipedal housing 2 is closed on its front side by a removable housing wall 2a which forms a narrow-side wall of the housing 2. The removable housing wall 2a forms the end wall 10 of the food slicer. In the end wall 10, a push-button 22 is arranged on a top surface of the end wall 10. The end wall 10 also bears a locking mechanism 23.

An opening A formed in the rear wall 4 is provided for receiving a rotary knob assembly. The rotary knob assembly allows the slicing width of the slicer to be adjusted. Specific information with regard to the rotary knob and other information may be found in our commonly assigned, copending application PCT/EP03/01757, which is herewith incorporated by reference.

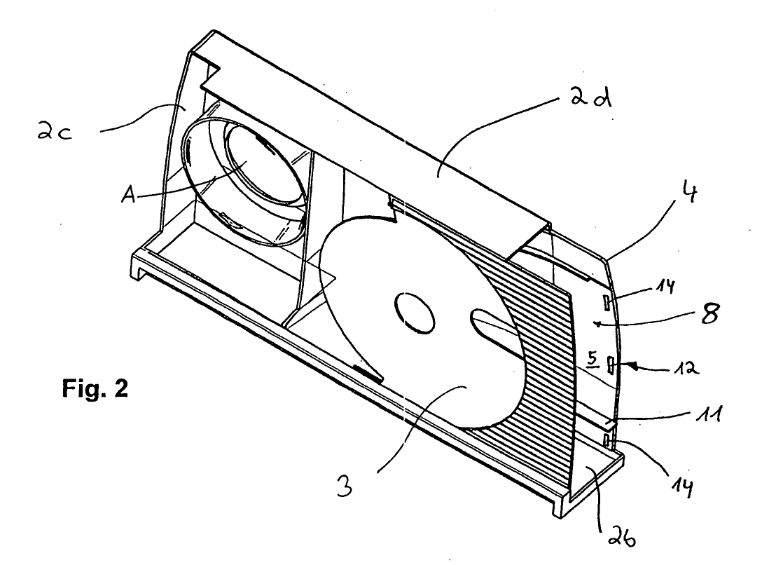

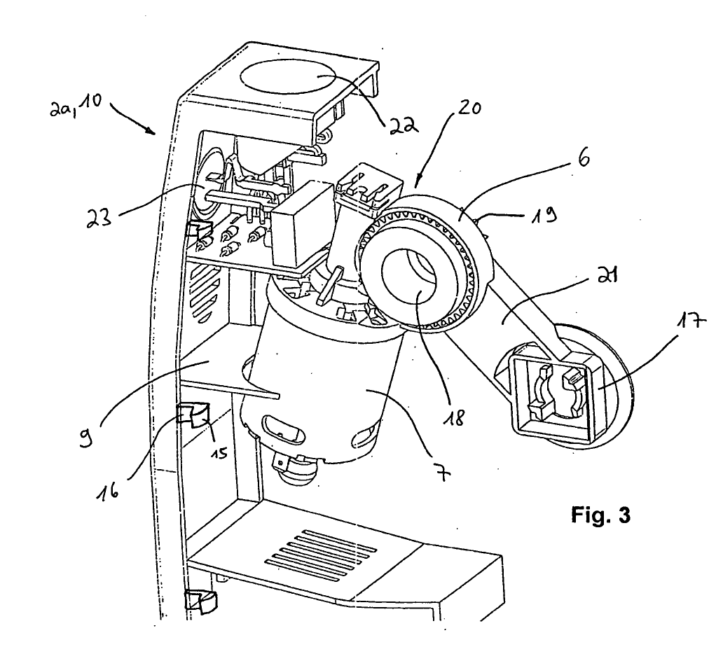

FIG. 2 shows the parallelepipedal housing 2, which is designed as a one-piece injection-molded plastic part. The housing 2 has a front wall 3 and a rear wall 4 disposed at a spacing distance from the front wall 3. An interspace 5 is formed between the front wall 3 and the rear wall 4. This interspace 5 is accessible via an opening 8. A carrier 9 (cf. FIG. 3) can be inserted into the interspace 5 of the parallelepipedal housing 2 via the opening 8. Guides 11, on which the carrier 9 of FIG. 3 can be inserted into the housing 2, are formed on the inner sides of the housing 2. The guides 11 are designed as formed-on strips on the inner walls of the front wall 3 and of the rear wall 4. A non-illustrated round blade can be disposed on the front side-of the front wall 3.

FIG. 3 shows a carrier 9 according to the invention. The carrier 9 is basically formed as a one-piece injection-molded plastic part and comprises the removable housing wall 2a or the end wall 10. Resilient catch hooks 16, which have retaining noses 15, are formed on the carrier 9. The retaining noses 15 engage in associated catch means 12 on the inner sides of the housing 2. The catch means 12 may be recesses, openings, or steps on the inner side of the front wall 3 and of the rear wall 4, as can be seen in FIG. 2. The carrier 9 is designed together with the end plate 10 as a one-piece component 21. The carrier 9 comprises a bearing plate 20 which carries a gear unit 6 and a drive motor 7. The gear unit 6 has a bearing assembly 18 (second bearing 18), wherein a drive pinion 19 is located. At a distance from the bearing assembly 18 there is disposed another bearing assembly 17 (first bearing 17) for the cutting blade. The first bearing 17 is held at a distance from the second bearing 18 by way of a one-piece component 21. All the components, comprising the drive motor 7, the gear unit 6, the first bearing assembly 17 and the second bearing assembly 18, are premounted on the carrier 9.

Additional information concerning an exemplary configuration of the drive unit may be found in our commonly assigned, copending application PCT/EP03/01756, which is herewith incorporated by reference.

Furthermore, a push-button 22 is integrated into the removable housing wall 2a. The end wall 10 has a locking mechanism 23 which, in the engaged position, locks the push-button 22. The completely premounted structural unit, that is, the premounted carrier 9 illustrated in FIG. 3, can be inserted into the parallelepipedal housing 2 of one-piece design, as illustrated in FIG. 2. The carrier 9 inserted into the housing 2 then forms the completed slicer according to FIG. 1.

1. A slicer, comprising:
a substantially parallelepipedal housing formed with a front wall, a rear wall spaced apart from said front wall and forming an interspace therewith;
said housing further having a plurality of relatively narrow side walls between said front wall and said rear wall, said side walls including a removable housing wall enabling access to said interspace between said front wall and said rear wall, and remaining side walls forming a unitary structure;
a drive unit configured for insertion into said interspace, said drive unit having a drive motor and a gear unit connected to said drive motor for driving a round cutting blade disposed at said front wall of said housing.

2. The slicer according to claim 1, wherein said removable housing wall is formed by a lateral end wall of the housing.

3. The slicer according to claim 1, wherein said remaining housing walls forming said housing along with said removable housing wall are interconnected in one piece.

4. The slicer according to claim 3, which comprises a carrier carrying said gear unit and said drive motor, and configured for insertion into the housing.

5. The slicer according to claim 4, wherein said carrier, upon insertion into said housing, is supported on at least one inner side of said housing.

6. The slicer according to claim 5, which comprises a guide formed on the inner side of said housing, and wherein said carrier is insertible into said housing by way of said guide.

7. The slicer according to claim 5, wherein said housing includes catch means and said carrier is fixed in said catch means.

8. The slicer according to claim 7, wherein said catch means are formed by recesses on the inner side of said housing, and retaining noses are fastened to said carrier with resilient catch hooks for engaging into said recesses.

9. The slicer according to claim 7, wherein said catch means are disposed in proximity of a first bearing assembly for the round cutting blade.

10. The slicer according to claim 7, wherein said catch means are disposed in proximity of a second bearing assembly for a driving pinion

11. The slicer according to claim 4, which comprises a bearing plate connected to said carrier, said bearing plate carrying said gear unit and said drive motor.

12. The slicer according to claim 4, wherein said carrier is connected to a lateral end wall of said housing.

13. The slicer according to claim 12, wherein said carrier and said lateral end wall are formed as a one-piece component.

14. The slicer according to claim 13, wherein said one-piece component is formed with stiffening ribs disposed to run between said carrier and said lateral end wall.

15. The slicer according to claim 13, wherein said one-piece component is an injection-molded plastic part.

16. The slicer according to claim 12, which further comprises a push-button disposed in said lateral end wall for switching said drive motor.

17. The slicer according to claim 16, wherein said lateral end wall is formed with a locking mechanism for said push-button.
